(19) United States
(12) Patent Application Publication
(10) Pub. No.: US 2010/0185356 A1
(43) Pub. Date: Jul. 22, 2010

(54) Compiling Source Information From A Motor Vehicle Data System and Configuring A Telematic Module

(75) Inventors: Gregory Alan Haas, Schaumburg, IL (US); Nathan Hoch, Fort Wayne, IN (US); Andrew Smith, Cedar Rapids, IA (US); Randall Roepke, Chicago, IL (US); Anthony S. Martinez, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/355,048

(22) Filed: Jan. 16, 2009

(51) Int. Cl. G06F 19/00; G06F 17/30

(52) U.S. Cl. 701/33; 701/35; 707/E17.044

(57) ABSTRACT

A method for configuring a telematic module (14) in a motor vehicle (10) in association with a motor vehicle electronic data system (12). A portable computer (22) is connected to the electronic data system to collect for each of certain vehicle parameters of interest, a list of identifiable data messages that are potentially available in the vehicle data system for each parameter. The collected data is used to arrange the lists in an ordered priority according to the source of the data in the vehicle. The ordered priority lists are used in a configuration program in a processor for configuring the telematic module to seek the highest priority message in each list for reporting. The module may be configured autonomously, by a portable computer, or wirelessly from a host Website.

### FIELD OF THE DISCLOSURE

This disclosure relates to telematic modules that are associated with electronic systems in motor vehicles for reporting vehicle data to a remote collection station.

### BACKGROUND OF THE DISCLOSURE

A vehicle telematic system typically comprises a telematic module that embodies wireless technology and GPS tracking technology that collectively enable data to be exchanged between the vehicle and a location remote from the vehicle. For example, data related to operation of multiple vehicles in a fleet can be automatically reported from each vehicle to a central location that monitors the fleet for various purposes such as vehicle diagnostics or tracking deliveries.

Truck and bus fleet managers may have different truck and bus brands and models on which they wish to install telematic modules. The installation process comprises configuring each module to a specific vehicle, including selecting the in-vehicle source for data that the module is to collect, such as a source of engine operating hours data, a source of fuel level data, or a source of distance traveled data. Single or multiple sources may exist in a particular vehicle for a particular data item, or no source may exist. Examples of sources are messages on data busses whose protocols are defined by various standards such as SAE standards J 1587, J1708, J 1850, (all serial busses) and J1939 (a Controller Area Network or CAN bus), and general purpose input/outputs (GPIO's). How to properly configure a module may be beyond the technical knowledge of an end user who is installing the module.

### SUMMARY OF THE DISCLOSURE

The present disclosure describes how a telematic module is enabled to be configured for a particular vehicle so that there is no need for an end user to possess detailed knowledge of data busses and sources of electronic data in the vehicle. The disclosure also describes a telematic module that can autonomously configure itself.

When a telematic module is to be configured for a particular vehicle in which it is being installed, the availability and source, or sources, of data-containing messages of interest in the vehicle are ascertained. This task can be performed by connecting a portable computer to a standard 9-pin diagnostic connector in the vehicle where various data messages can be read. The computer contains a program that examines data messages and collects information that identifies the particular protocol of each message including the source of the message. Such information is rendered identifiable to the computer because each message will be in a known standardized format such as is true for serial data messages appearing on a serial data bus and CAN messages appearing on a CAN bus. The SAE standards mentioned above have been promulgated by the Society of Automotive Engineers (SAE) to define communication protocols between electronic devices in motor vehicles. A program known as “Aware Config” is a program that can be installed in a portable computer for collecting this message information.

The collected data is then processed and used to configure the telematic module for enabling the module to transmit vehicle data to a remote receiving station when the vehicle is in use and distant from the station. Configuration of the module can be performed remotely from a host Aware Website.

Alternately, a telematic module may configure itself autonomously after having been installed in a vehicle. A data processor in the module operates to examine data messages on vehicle data busses and collect information that identifies the particular protocol of each message including the source of the message in the same way as described above using a portable computer running “Aware Config”. The module processor then autonomously configures the module.

The processor of the telematic module that configures itself comprises, for each configurable parameter, a list of identifiable messages for that particular parameter that are potentially available in a particular vehicle. The identifiable messages in each list are arranged in a selected order of priority based on the message source. The values of certain parameters may be read from different sources, i.e. different devices or algorithms that generate the parameter values. Some sources for a particular parameter may be considered more accurate and/or may be more frequently updated than others.

Regardless of which one of these two methods is used to configure the module, the module operates to report data for each parameter of interest by reading messages on the data bus or busses while seeking to identify a message corresponding to the highest priority one on the respective list for the particular parameter. The configuration process may also or alternately request particular messages in an order of priority for each parameter.

If no message corresponding to the highest priority one on a list for a particular parameter is read, or received, after some period of time, then the configuration process seeks a message corresponding to the next highest priority on the list.

The process continues down the list in this manner either until a message on the list is identified, or until the list is exhausted. If the list is exhausted, then the data value for the parameter is considered unavailable, but the process could be repeated in the hope of still finding a value for the particular parameter. If multiple messages on a prioritized list are read during a timed interval, but not the highest priority message, the highest priority of the read messages may be used for reporting.

By using the methods described here for configuring a telematic module, the possibility of an end user error in configuring the module may be avoided, or at least significantly reduced.

The disclosure also relates to a method for ascertaining what specific data-containing messages are available in a motor vehicle's data system.

A portable computer is connected to the standard diagnostic connector and operated to scan one or more data busses on which data may appear in any of various protocols to ascertain messages that are supported in a particular vehicle. Supported messages are identified and collected. At a data collection facility they are subsequently processed and used in any of various ways such as for developing prioritized lists for configuring telematic modules.

Additionally, collected information about a specific vehicle's messages can be correlated with vehicle-specific information, such as make, model, and VIN number, transmitted such as by e-mail to a website host at the collection facility, to build a configuration database and lookup table based on multiple vehicles.

The “Aware Config” program has been developed and is used in conjunction with International Truck's IC4/IC3 EZ-Tech cable to collect information from a vehicle. The “Aware Config” program is installed in a portable laptop computer that is the connected to the diagnostic connector in the vehicle via the IC4/IC3 EZ-Tech cable. The program operates to scan a vehicle's data bus or busses for supported messages. It then reports the supported messages and the collected information is then used to configure the telematic module for a particular vehicle.

One general aspect of the disclosure relates to a method for configuring a telematic module that is being installed in a motor vehicle in association with a motor vehicle electronic data system.

The method comprises: connecting a portable computer to the electronic data system to collect for each of certain vehicle parameters of interest, a list of identifiable data messages that are potentially available in the vehicle data system for each parameter; using the collected data to arrange the lists in an ordered priority according to the source of the data in the vehicle; and using the ordered priority lists in a configuration program in a processor for configuring the telematic module to seek the highest priority message in each list for reporting.

Another general aspect relates to a system for enabling a telematic module to autonomously configure itself when installed in a motor vehicle in association with an electronic data system of the vehicle.

The system comprises: a data base in the telematic module containing for each of certain vehicle parameters of interest, a list of identifiable data messages that are potentially available in the vehicle data system with each data message having an ordered priority in the list according to the source of the data; and a data processor in the telematic module for identifying particular data messages in each list that are available in the vehicle data system and configuring the telematic module to first report the highest priority of available data messages for each parameter of interest when reporting data.

Another general aspect relates to a system for configuring a telematic module being installed in a motor vehicle in association with an electronic data system of a motor vehicle.

The system comprises: a data processor a) that is external to the vehicle, b) that can be communicated to the data system of the motor vehicle for configuring the telematic module, b) that for each vehicle parameter of interest in the data system that the module is to report contains an ordered priority list according to the in-vehicle source in a configuration program that when run to configure the module will configure the module to seek the highest priority message in each list for reporting.

Another general aspect relates to a method of developing a data base containing for each of multiple vehicles in the data base a list of data messages that are supported in an electronic data system of the vehicle.

The method comprises for each vehicle, operating a data processor to scan the data system for identifiable data messages, compiling a list of supported messages, and entering the list in the data base in correlation with additional data identifying the specific vehicle from which the list was compiled.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a schematic diagram relating generally to vehicle telematics.

FIG. 2 is a schematic diagram relating to one aspect of the disclosed subject matter another aspect.

FIG. 3 is a schematic diagram relating to another aspect.

FIG. 4 is schematic diagram showing more detail.

### DETAILED DESCRIPTION

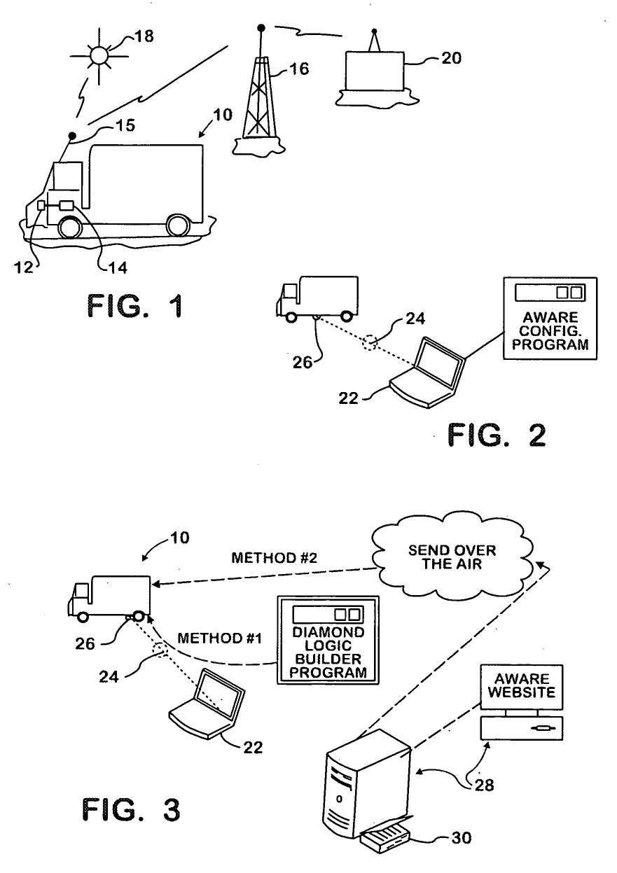

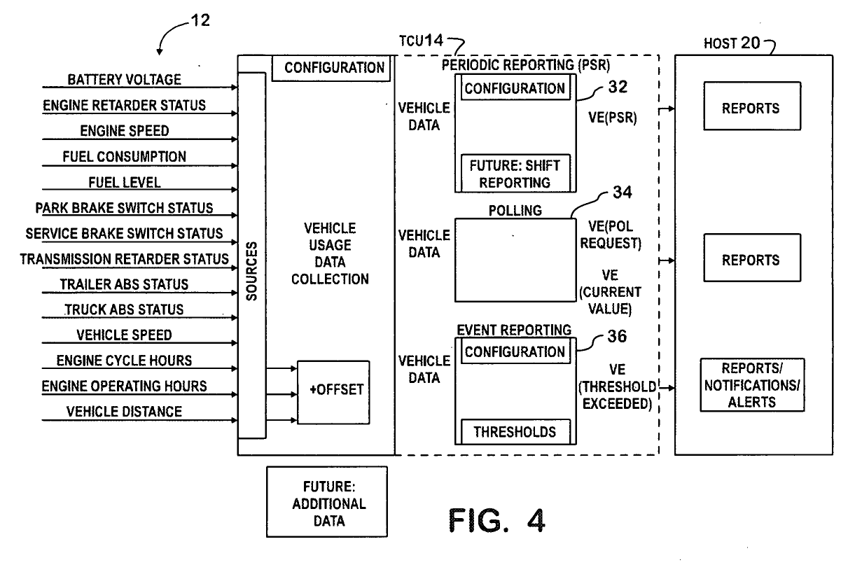

FIG. 1 shows a mobile vehicle 10, a truck for example, having an electronic data system 12. A telematic module 14 is installed in vehicle 10 in association with data system 12. When installed, module 14 can wirelessly communicate through an antenna system 15 bi-directionally with a tower 16 in a cellular communications system and with one or more satellites 18 of the Global Positioning System. The cellular communications system provides bi-directional communication with a land-based station 20 remote from vehicle 10 to complete the transmission path between the station and the vehicle.

Before module 14 is configured, message data in data system 12 is obtained. FIG. 2 shows a portable laptop computer 22 connected via a cable 24 with a diagnostic connector 26 in vehicle 10. Computer 22 has a data processor that contains the “Aware Config” program mentioned above. A person operates computer 22 to run the program so that the message data is collected in the computer.

The “Aware Config” program examines data messages on the vehicle's data bus or busses and collects information about identifiable messages. Such information is rendered identifiable to computer 22 because the messages are Controller Area Network (CAN) ones that appear on a CAN bus in vehicle 10 or serial data on a serial bus. The messages may be in any one or more of known standard protocols, such as the ones mentioned earlier.

The collected information is then provided in any suitably appropriate way to a facility such as an “Aware Website” 28 (FIG. 3) where the information is processed to enable module 14 to be configured for vehicle 10 by either of the methods discussed earlier. When multiple sources are available in the vehicle for a parameter of interest, the processing arranges them in a list having an ordered priority based on message source. The order of priority is determined by one or more technically skilled individuals who are familiar with the particular sources. For a particular parameter of interest, module 14 is configured to report the highest priority message, but if that particular message is not found within an allowable search time, then the highest priority found message is reported.

When the module is to be configured by using a computer such as computer 22 connected to connector 26, the processed information is input to the Diamond Logic Builder program in computer 22, as shown by Method #1 in FIG. 3. With the computer connected to vehicle data system 12 via connector 26, a person operates the computer to run the Diamond Logic Builder program. Running of the program configures module 14 for vehicle 10.

When module 14 is to be configured from “Aware Website 28” the module is configured for vehicle 10 in a wireless manner via cellular communication.

The configuration process results in the module operating to first report the highest priority data message in each list when reporting information for the respective parameter of interest to station 20, and to report the next highest priority data message in each list if the highest priority in the list is unavailable for a report. If no message is found during the allowed time for finding a message, the parameter is reported as unavailable.

When configured, the installed module 14 has access to the electronic data system in vehicle 10. When polled by station 20, module 14 reports information. Module 14 may also transmit information on its own initiative (periodic reporting) or when an exception occurs.

Website 28 also collects vehicle-specific information to identify the particular vehicle in correlation with the particular data messages available in the vehicle data system. The vehicle-specific information may include VIN number, vehicle make, and/or vehicle model. By doing the same for many different vehicles, database 30 can compile a database of identifiable vehicles in correlation with the particular data messages available in their respective vehicle data systems. This can be valuable to a fleet operator who has different vehicle makes and models and who may not have had an accurate or complete knowledge of data that is available for reporting. It also enables specific types of reports to be made that show how different vehicles in a fleet are performing on a component-by-component or system-by-system basis.

It also enables a module in a vehicle not already in database 30 to be configured based on other identical or similar vehicle models already in the database. For example, a VIN number contains some information about the make, year and model of the vehicle. Vehicles having certain similarities in VIN numbers may have similar or even identical electronic data systems, and thereby enable a module in a vehicle not in the database to be configured using configuration data from a similar one already in the data base. Even if the configuration is not perfect, it may be sufficient or at least facilitate the process of achieving perfect configuration. In the case of configuring a module by computer 22, the Diamond Logic Builder program adapted for the particular vehicle uses VIN-based data from the data bank. In the case of wireless configuration, the VIN number of the vehicle containing the module to be configured can be supplied wirelessly from the module to the Website where the configuration program is adapted for the vehicle based on similarity to data already in the data base.

FIG. 3 shows a general diagram of certain portions of module 14 and a host corresponding to station 20. Representative vehicle parameters of interest are shown along the left of the Figure. When the configured module 14 is in use in vehicle 10, it collects data according to the method described above. Some data is collected and used with the value as collected, while some data may have offsets applied to it before reporting. For example, if a component that has historical data, such as odometer data, engine hours, or the like is replaced, the historical data is added as an offset.

Data may be reported to station 20 in one or more of several different ways: periodic reporting 32 at configured intervals; responding to requests from the host (polling 34); and event reporting 36 when configured thresholds are exceeded. The host uses this vehicle data for a variety of reports, notifications, and/or alerts.

Examples of useful vehicle data collected for use in developing Vehicle Usage Reports may include battery voltage, engine idle hours, engine operating hours, engine retarder (brake) status, engine speed, fuel consumption, fuel level, parking brake switch status, service brake switch status, transmission retarder status, trailer ABS status (when the vehicle is towing a trailer), vehicle ABS status (truck ABS status when the vehicle is a truck), vehicle distance (odometer), and vehicle speed.

Using this data, module 14 can also provide event reporting 36 of events such as the following to the host: battery voltage exception, engine overspeed exception, vehicle overspeed exception, rapid deceleration exception, fuel level low exception, and rapid acceleration exception.

Module 14 can also report the current status of various vehicle data when requested by the host (polling 34), and on a periodic basis, summarize vehicle data over the previous periodic interval and report the summary to the host.

1. A method for configuring a telematic module that is being installed in a motor vehicle in association with a motor vehicle electronic data system, the method comprising:
connecting a portable computer to the electronic data system to collect for each of certain vehicle parameters of interest, a list of identifiable data messages that are potentially available in the vehicle data system for each parameter;
using the collected data to arrange the lists in an ordered priority according to the source of the data in the vehicle; and
using the ordered priority lists in a configuration program in a processor for configuring the telematic module to seek the highest priority message in each list for reporting.

2. A method as set forth in claim 1 in which the step of using the ordered priority lists in a configuration program in a processor for configuring the telematic module to seek the highest priority message in each list for reporting comprises running the configuration program in a processor of a portable computer connected to the vehicle electronic data system.

3. A method as set forth in claim 2 in which the portable computer is connected to a diagnostic connector in the vehicle.

4. A method as set forth in claim 1 in which the module is configured to report the highest priority message that is found in each list during a scan of the electronic data system.

5. A method as set forth in claim 1 in which the module is configured to report the next highest priority data message that is available in each list if the highest priority in the list is unavailable for a report.

6. A method as set forth in claim 1 in which the step of using the ordered priority lists in a configuration program in a processor for configuring the telematic module to seek the highest priority message in each list for reporting comprises running the configuration program in a processor at a site remote from the vehicle and wirelessly configuring the module via a cellular system.

7. A system for enabling a telematic module to autonomously configure itself when installed in a motor vehicle in association with an electronic data system of the vehicle, the system comprising:
a data base in the telematic module containing for each of certain vehicle parameters of interest;
a list of identifiable data messages that are potentially available in the vehicle data system with each data message having an ordered priority in the list according to the source of the data;
a data processor in the telematic module for identifying particular data messages in each list that are available in the vehicle data system; and
configuring the telematic module to first report the highest priority of available data messages for each parameter of interest when reporting data.

8. A system as set forth in claim 7 in which the telematic module is configured to report the next highest priority data message in each list if the highest priority in the list is unavailable for a report.

9. A system for configuring a telematic module being installed in a motor vehicle in association with an electronic data system of a motor vehicle, the system comprising:
an data processor a) that is external to the vehicle, b) that can be communicated to the data system of the motor vehicle for configuring the telematic module, c) that for each vehicle parameter of interest in the data system that the module is to report contains an ordered priority list according to the in-vehicle source in a configuration program that when run to configure the module will configuring the module to seek the highest priority message in each list for reporting.

10. A system as set forth in claim 9 in which the telematic module is configured to report the next highest priority data message in each list if the highest priority in the list is unavailable for a report.

11. A method of developing a data base containing for each of multiple vehicles in the data base a list of data messages that are supported in an electronic data system of the vehicle, the method comprising:
for each vehicle, operating a data processor to scan the data system for identifiable data messages, compiling a list of supported messages; and
entering the list in the data base in correlation with additional data identifying the specific vehicle from which the list was compiled.

12. A method as set forth in claim 11 further comprising processing data in the data base to create data for configuring a telematic module in a particular vehicle.
